(19) United States
(12) Patent Application Publication
(10) Pub. No.: US 2014/0350743 A1
(43) Pub. Date: Nov. 27, 2014

(54) TIERED POWER MANAGEMENT SYSTEM FOR MICROGRIDS

(71) Applicant: NEC Laboratories America, Inc., Princeton, NJ (US)

(72) Inventors: Babak Asghari, San Jose, CA (US); Ratnesh Sharma, Fremont, CA (US); Ali Hooshmand, Campbell, CA (US)

(21) Appl. No.: 14/321,931

(22) Filed: Jul. 2, 2014

Related U.S. Application Data
(63) Continuation-in-part of application No. 13/858,033, filed on Apr. 6, 2013.
(60) Provisional application No. 61/842,471, filed on Jul. 3, 2013.
(60) Provisional application No. 61/693,466, filed on Aug. 27, 2012.

(51) Int. Cl. G05B 13/04

(52) U.S. Cl. CPC G05B 13/048
USPC 700/297

(57) ABSTRACT

Systems and methods to perform multi-objective energy management of micro-grids include determining, by an advisory layer with Model Predictive Control (MPC) using a processor, long-term power management directives that include a charging threshold that characterizes one or more power sources, where the advisory layer provides optimal set points or reference trajectories to reduce a cost of energy; and determining real-time actions based on the charging threshold to adaptively charge a battery from the one or more power sources or to discharge the battery.

### RELATED APPLICATION INFORMATION

This application is a non-provisional of and claims priority to provisional application Ser. No. 61/693,466 filed on Aug. 27, 2012, the content of which is incorporated by reference. This application further claims priority to provisional application Ser. No. 61/842,471 filed on Jul. 3, 2013, the content of which is incorporated by reference. This application is a continuation-in-part of co-pending application Ser. No. 13/858,033, filed on Apr. 6, 2013, the content of which is incorporated by reference.

### BACKGROUND

The present invention relates to multi-objective energy management methods for micro-grids.

A micro-grid is the integration of loads, energy resources, and storage devices. From the operating point of view, a micro-grid is counted as one independent entity which is able to work either in grid-tied or islanded mode. Micro-grid's energy resources can include utility connection, micro-gas turbines and renewable generations such as fuel cells, wind turbines, and solar panels. It is expected and desirable that a considerable amount of demand for each micro-grid is supplied by its own renewable generations. On the other hand, the intermittent nature of most distributed generations (DGs) such as wind and photovoltaic (PV) introduces a significant uncertainty in the operation of a micro-grid. This makes the conventional unit commitment more erroneous and unreliable. Therefore, a real-time management framework as a supervisory control is an absolute necessary procedure within a micro-grid similar to the various regulatory actions in conventional power systems. The first objective for this management system is real-time dispatching of energy generations in a way that minimizes the operational cost while it guarantees the balance between supply and demand at the presence of unpredictable variations of DGs.

In order to relax the issue of sudden unpredicted unbalances between supply and demand, energy storage devices are normally utilized. Among various types of storage devices, batteries are most favorable option and also the most expensive component of micro-grid. In grid-tied micro-grids, any shortage in the supply side (power outputs from DGs and the scheduled power from the grid) should be met whether by the battery or by purchasing extra power from the grid or a combination of both. At the first glance, it might be preferred to use battery first since it is charge free. But irregular usage pattern of batteries shortens their life span and may cause a replacement cost for batteries. Three parameters affect batteries' life: 1—Depth of discharge (DOD) 2—Discharge power and 3—temperature.

It is expected and desirable that a considerable amount of demand for each micro-grid is supplied by its own local generations. The intermittent nature of most distributed generations (DGs) introduces a significant uncertainty in the operation of a micro-grid. Having more comprehensive forecasting about the renewable generations, we are able to manage the micro-grid more efficient. Hence, a long term predictive controller seems to be necessary to make the optimal decisions based on long term forecasted profiles of renewables and load. On the other hand, we need a real-time manager. It means the controller should be able to guarantee the second-by-second balance between supply and demand and deal with all fluctuations in the system. Hence, as the first problem, a management system is required to optimize both long term predictive control objective and real-time control objective simultaneously.

In order to relax the issue of sudden unpredicted unbalances between supply and demand, battery is normally utilized which is also the most expensive component of micro-grid. On the other hand, irregular usage pattern of battery shortens its life span and may cause a replacement cost for battery. Based on this idea, in micro-grids operation, it should be tried to utilize battery's power in a way that maximizes their lifetime. Therefore, maximizing the battery lifetime is an important objective that should be considered besides the energy cost minimization objective in the operation of micro-grids. Therefore, as the second problem, a multi-objective management system is needed to optimize the battery lifetime and energy cost at the same time.

Previous attempts were based on passive control of energy storage units. An example is schedule-based control in which a storage unit charges and discharges at certain times during the day. There are also some other researches which attempt to optimize the operation of micro-grid by solving an optimization problem. But they just consider and minimize the energy cost of operation; thus they cannot guarantee an optimal operation of the storage unit.

### SUMMARY

A method to perform multi-objective energy management of micro-grids includes determining, by an advisory layer with Model Predictive Control (MPC) using a processor, long-term power management directives that include a charging threshold that characterizes one or more power sources, where the advisory layer provides optimal set points or reference trajectories to reduce a cost of energy; and determining real-time actions based on the charging threshold to adaptively charge a battery from the one or more power sources or to discharge the battery.

A multi-objective energy management system includes a processor coupled to a micro-grid; a long term scheduler in an advisory layer with a Model Predictive Control (MPC) that uses the processor to determine long-term power management directives that include a charging threshold that characterizes one or more power sources; and a real-time controller that determines real-time actions based on the charging threshold to adaptively charge a battery from one or more power sources or to discharge the battery.

### BRIEF DESCRIPTION OF THE DRAWINGS

FIG. 1 represents an exemplary micro-grid.

FIG. 2 shows an exemplary process for multi-objective energy management methods for micro-grids.

FIGS. 3A-3D shows two exemplary multi-objective management methods for long term optimizations with a real time controller and with battery lifetime maximization.

FIGS. 4A-4B shows another exemplary multi-objective energy management method for micro-grids.

FIG. 5 shows a two-tiered power management system in accordance with the present principles.

FIG. 6 shows a block/flow diagram of a method of power management in accordance with the present principles.

FIG. 7 shows a block/flow diagram of a method for finding advisory-layer solutions in accordance with the present principles.

FIG. 8 is a diagram of a 24-hour period, broken into different tariff periods, in accordance with the present principles.

FIG. 9 is a block/flow diagram of a modified multi-objective management method that takes into account energy production thresholds.

### DESCRIPTION

Multi-objective energy management methods are disclosed for micro-grids that include local generations, grid connection, energy storage units and various loads. Minimization of energy cost and maximization of battery's lifetime are considered as two objectives which should be optimized simultaneously. Model predictive control (MPC) policy is utilized for solving the optimization problem and real-time implementation in a closed-loop framework. MPC is a class of control policies which uses a model that projects the behavior of system. Based on this model, controller can predict the future response of the system to various control actions; and based on this prediction, makes the optimal solution. For problems such as power system dispatching which highly depends on forecasted value of demand and renewable energy productions, this method can be effective. In addition, due to its important characteristic which is its close-loop nature, it corrects any in error in load and renewable generations' forecasting in the next iteration and so, extremely helps system stability and robustness. Furthermore, MPC can be appropriately embedded into the real-time management framework since it works dynamically and based on receding horizon control policy. Finally, it should be noticed that MPC is one of the few algorithms which can handle dynamic constraints such as batteries' state of charge (SoC) difference equation. Hence, the challenge of this paper is to propose a novel multi-objective optimization problem for real-time managing of micro-grids via implementation of model predictive control strategy.

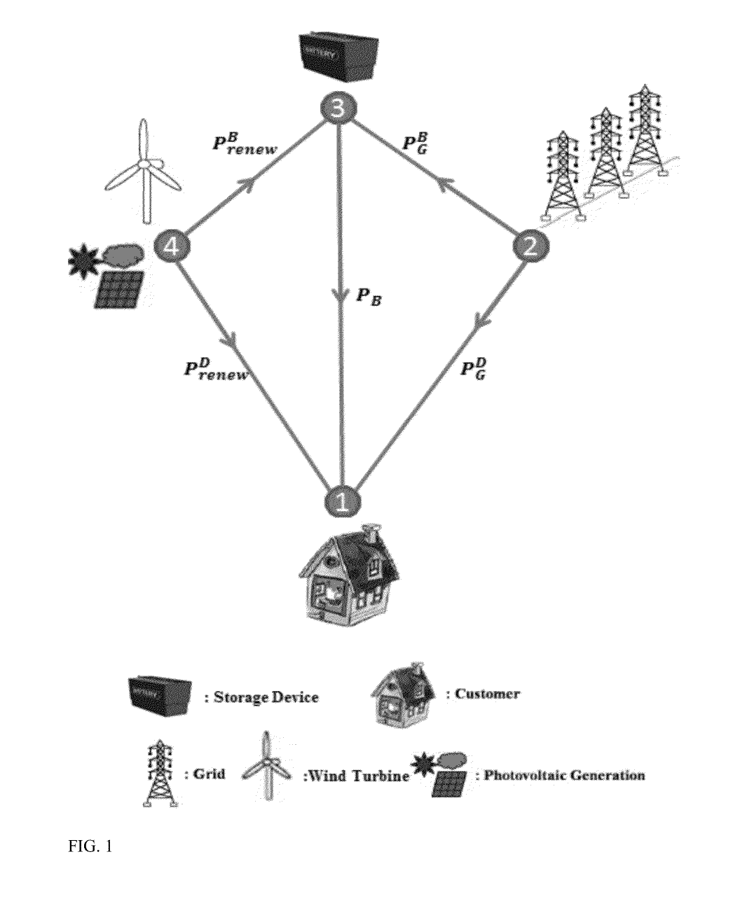

In one embodiment, the micro-grid is modeled as a directed graph which includes four nodes as illustrated in FIG. 1. First node represents demand. The profile of demand, D(t), is assumed to be forecasted perfectly and without any prediction error. Node 2 is imported power from the grid, P_{G}(t), which can be sent directly to demand node, P_{G}^{D}(t), (from node 2 to node 1 in FIG. 1), and/or stored in battery, P_{G}^{B}(t) (from node 2 to node 3). Hence, at each time, t,:

P_{G}(t)=P_{G}^{D}(t)+P_{G}^{B}(t) (1)

Node 4 represents total generated power by renewable sources such as PV and wind turbine, P_{renew}(t). Since this power is uncontrollable with almost free marginal cost, it should be tried to consume it directly by load, P_{renew}^{D}(t) (from node 4 to node 1 in FIG. 1), and/or store it in the battery, P_{renew}^{B}(t) (from node 4 to node 3), as much as possible. Finally, node 3 is storage device node which is a package of battery in this paper. As mentioned, the battery can be charged by renewable source, P_{renew}^{B}(t), and grid power, P_{G}^{B}(t). P_{B}(t) is battery discharge power which goes from node 3 to node 1 in FIG. 1) for supplying the load. Considering the micro-grid's directed graph and its elements, we design an optimization problem in order to optimally dispatch different energy sources within the micro-grid. Similar to other optimization problems, the proposed mathematical formulation has two main parts: Objective function which should be optimized, and static and dynamic constraints of micro-grid which should be satisfied.

For the above micro-grid, the system optimizes two variables: 1—Minimizing the cost of energy, 2—Maximizing the battery lifetime.
1) Cost of Energy: In every power dispatching problem, primary objective is to schedule the generators output to reliably supply the power requested by end users. This scheduling should be implemented in a cost-efficient way. In one system, cost of energy is the cost of importing power from the grid. Hence, first objective function J₁ is the grid power cost over the optimization window. We assume the marginal cost of grid power for any level of generation is constant. Therefore, J1 is simply modeled by a linear equation as follows:

$${J}_{1} := {\sum }_{t = 0}^{T} {C}_{G} ( t ) {P}_{G} ( t ) \qquad ( 2 )$$

in which T is optimization horizon, P_{G}(t) is imported power from grid at time t, and C_{G}(t) is grid power price at time t that is extracted based on time-of-use grid electricity rates information.
2) Battery's Lifetime Extension: To formulate the objective of battery lifetime maximization and integrating with energy cost minimization, the maximization problem is translated into a minimization one. To this purpose, battery lifetime is estimated using its cumulative discharges and its DoD. For a battery cell which has been operated for a certain period of time and experienced k discharge events, the estimated lifetime, BL, can be calculated as follows:

$$BL = \frac{{L}_{R} {D}_{R} {C}_{R}}{{\sum }_{i = 1}^{k} {d}_{eff} ( i )} τ \qquad ( 3 )$$

in which C_{R} is rated amp-hour capacity at rated discharge current, D_{R} is DoD for which rated cycle life was determined, and L_{R} is cycle life at rated DoD and rated discharge current. d_{eff}(i) is the effective discharge (ampere-hours) for a particular discharge event i and is calculated as follows:

$${d}_{eff} ( i ) = ( \frac{DoD ( i )}{{D}_{R}} ) {x}_{1} {e}^{{x}_{2} ( \frac{DoD ( i )}{{D}_{R}} - 1 )} \frac{{C}_{R}}{{C}_{A} ( i )} {d}_{act} ( i ) \qquad ( 4 )$$

in which DoD(i), C_{A}(i), and d_{act}(i) are DoD, actual capacity of a battery, and measured discharge ampere-hours for ith discharge event respectively. Coefficients x₁ and x₂ are calculated by applying a curve fitting procedure to cycle life versus DoD data available from the battery data sheet. To perform curve fitting task, particle swarm optimization (PSO) technique is employed. PSO is a curve fitting tool compatible with nonlinear battery characteristics.

Having the estimated life time, the system can evaluate the number of needed replacement for batteries for the total life of project. According to number of required replacement, equivalent uniform annual cost (EUAC) is calculated. Finally, once the EUAC is determined, the price of power extracted from the batteries is calculated by dividing EUAC by the expected annual kWh usage of the battery. In summary, the cost of battery usage (second objective, J₂) can be modeled as follows:

$${J}_{2} := {\sum }_{t = 0}^{T} {C}_{B} ( {P}_{B} ( t ) , DoD ( t ) ) {P}_{B} ( t ) \qquad ( 5 )$$

in which P_{B}(t) is battery discharge power which is obtained from measured discharge ampere-hours at time t, and C_{B}(P_{B}(t), DoD(t)), is the price of battery power that is a function of discharge power and its DoD at time t.

By transferring battery's life time maximization problem into a battery's power cost minimization problem, we are able to embed two above-mentioned objectives into a single optimization problem in which the objective function, J, can be achieved as follows:

$$J := {\sum }_{t = 0}^{T} {C}_{G} ( t ) {P}_{G} ( t ) + {C}_{B} ( {P}_{B} ( t ) , DoD ( t ) ) {P}_{B} ( t ) \qquad ( 6 )$$

The operational and physical constraints of problem are listed as follows:
1) Supply-Demand balance which is an equality constraint and the main responsibility of management system. This constraint is formulated as follows:

P_{G}^{D}(t)+P_{B}(t)+P_{renew}^{D}(t)=D(t) (7)

which means the summation of generated power by grid, battery, and renewable source should be equal to demand at each time.
2) Battery state of charge (SoC) difference equation:

soc(t+1)=soc(t)−αP_{B}(t)+αP_{G}^{B}(t)+αP_{renew}^{B}(t) (8)

in which soc(t) is battery SoC in ampere-hour (Ah) at time t, and α is a coefficient which changes kW unit into Ah.
3) Upper and lower bound for battery SoC which by considering the SoC difference equation (8) will be a dynamic inequality constraint:

soc^{min}≦soc(t)≦soc^{max} (9)
4) All decision variables (P_{G}^{D}(t), P_{G}^{B}(t), P_{renew}^{D}(t), P_{renew}^{B}(t), and P_{B}(t)) are physical variables. Therefore, they are always greater than or equal to zero:

P_{G}^{D}(t)≧0, P_{G}^{B}(t)≧0, P_{B}(t)≧0,

P_{renew}^{D}(t)≧0, P_{renew}^{D}(t)≧0, (10)
5) Renewable inequality constraint which states that the summation of P_{renew}^{D}(t) and P_{renew}^{B}(t) should be less than or equal to available renewable generation at each time. Thus, we have:

P_{renew}^{D}(t)+P_{renew}^{B}(t)≦P_{renew}(t) (11)

in which P_{renew}(t) is the available renewable power at time t and is obtained based on forecasted profile of renewable generations.
6) Peak shaving inequality constraint which equips the management system with the ability of performing peak shaving task. By satisfying this constraint, management system guarantees that the total extracted power from the grid at each time is less than a predetermined constant value, P_{PSH}. Therefore, we state this inequality constraint as follows:

P_{G}^{D}(t)+P_{G}^{B}(t)≦P_{PSH} (12)

This constraint is an optional objective for management system and is not a mandatory task for normal type of operation.

For defining and solving optimization problem, it will be enough to pick P_{G}^{D}(t), P_{G}^{B}(t), P_{renew}^{D}(t), and P_{renew}^{B}(t) as decision variables since other variables can be described based on this parameters. Hence, the optimal dispatching problem for the finite horizon T becomes:

$${{min}_{{P}_{G}^{D} , {P}_{renew}^{D} ,}}_{{P}_{G}^{B} , {P}_{renew}^{B}} J := {\sum }_{t = 0}^{T} {C}_{G} ( t ) {P}_{G} ( t ) + {C}_{B} ( {P}_{B} ( t ) , DoD ( t ) ) {P}_{B} ( t )$$

$$subject to \text{:} ( 7 ) - ( 12 )$$

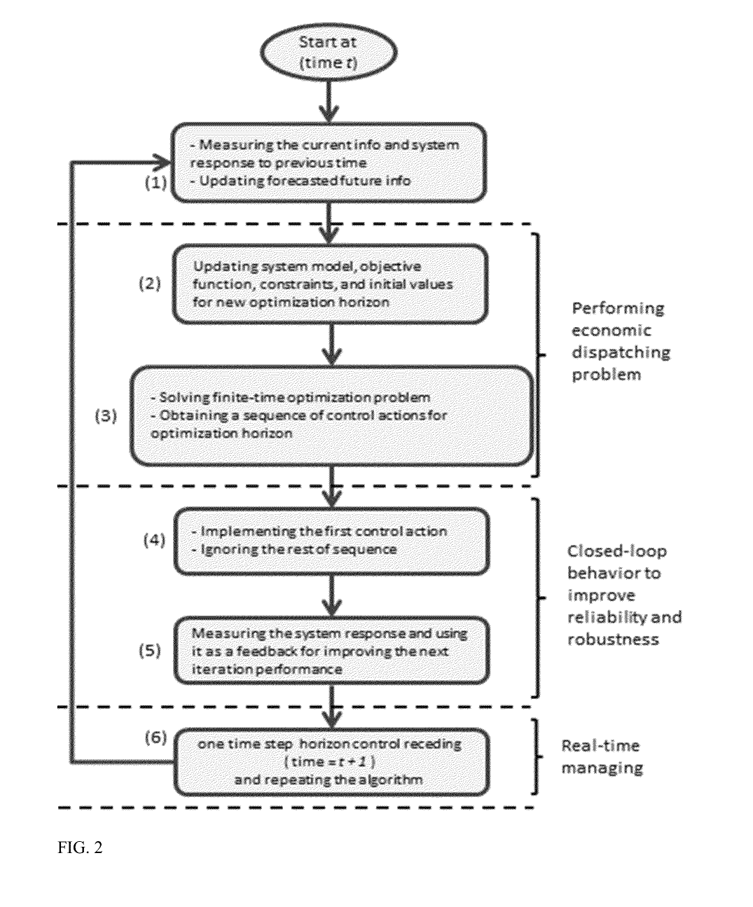

Next, a model predictive control (MPC) framework is described and applied to solve the proposed real-time management problem. MPC is a control methodology that utilizes a model of the system under control. Using the system model, MPC can predict the system behavior to different control actions. For making the model of operation for micro-grid, current and future information is needed including forecasted load and renewable generations profiles, time-of-use grid electricity rates, current battery SoC, SoC model for battery charging and discharge, battery power pricing model, among others. In this way, MPC will be able to perform the real-time management task based on the process of FIG. 2. As shown in FIG. 2:
Step 1: Current system information and system response to previous inputs are measured. In addition, forecasted profiles are updated for new optimization horizon.
Step 2: Based on update information, system model, optimization objective function, and constraints are updated.
Step 3: The proposed economic dispatching problem is solved which results in a sequence of control actions for each time instance of optimization horizon.
Step 4: The first control action is implemented which means the output of each energy source and battery is determined for current time. The rest of the control sequence will be ignored.
Step 5: System response (new level of battery SoC, battery power price, etc.) to injected control command is measured and utilized as a feedback for next iteration to improve system performance.
Steps 4 & 5 together help the management system to perform a closed-loop control algorithm. Closed-loop characteristic makes the MPC to be robust and reliable for dealing with errors in system modeling and forecasting the renewable generations and load profiles.
Step 6: Horizon control recedes just one time step and MPC repeats the algorithm by going back to step 1. Step 6 lets the MPC act as an on-line manager for micro-grid which optimizes its behavior in every time step.

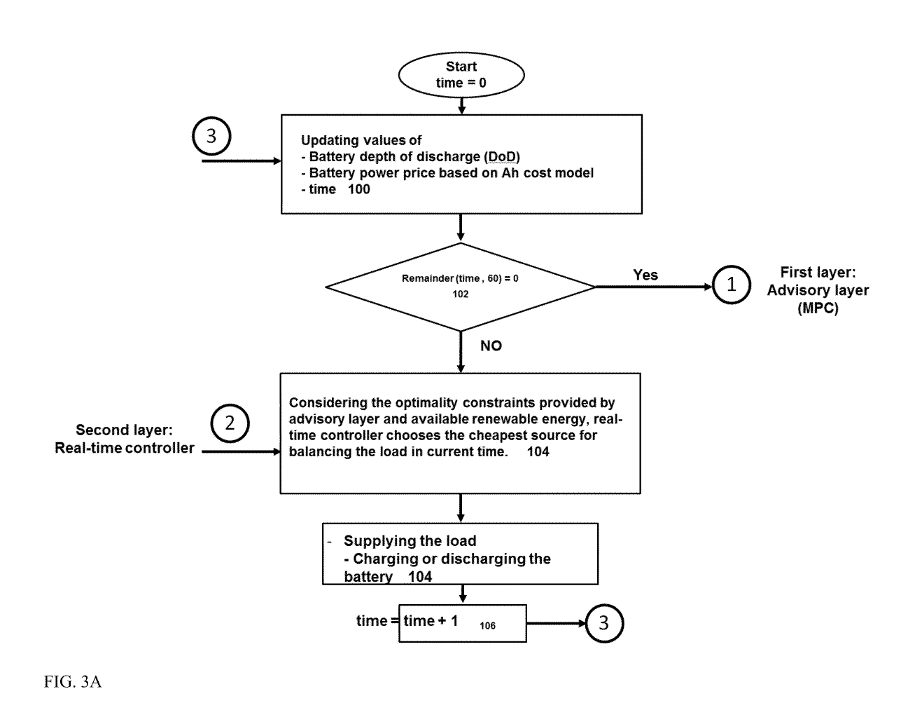

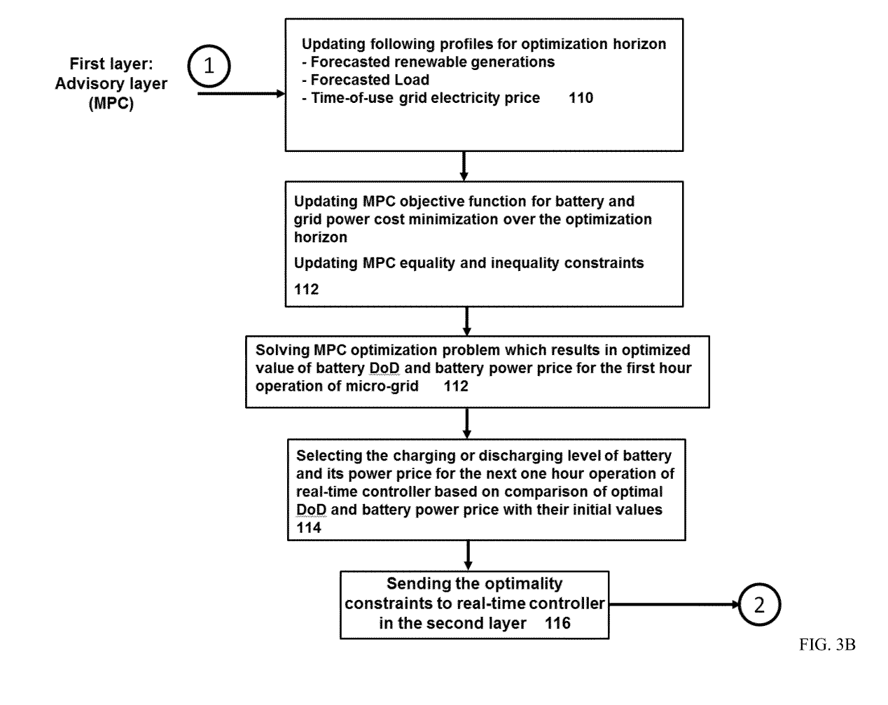

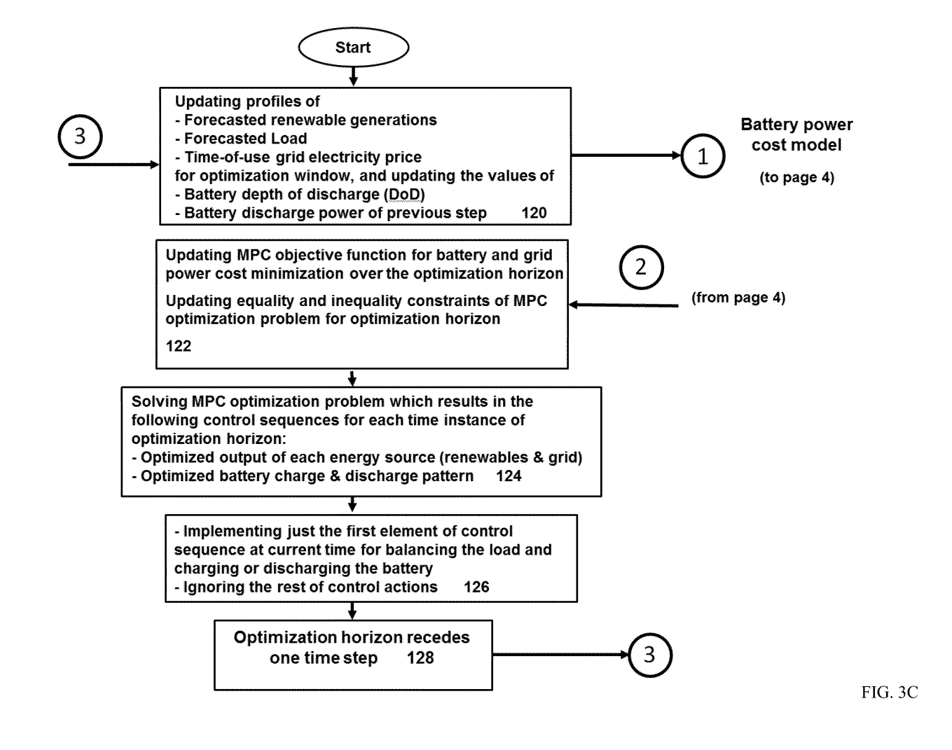

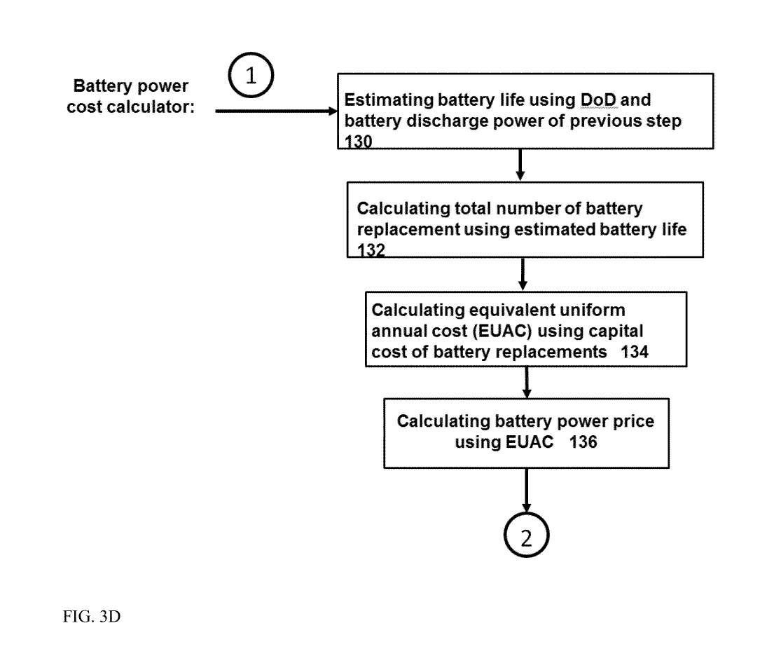

FIGS. 3A-3B shows other multi-objective energy management methods for micro-grids. In FIG. 3A, at the start, t=0, the process updates the time and the values of the battery depth of discharge (DoD) and battery power price based on an amper-hour cost model (100). In 102, the process checks if it is time for the advisory layer to run, which is hourly for one embodiment. If so, the process proceeds to connector 1 in FIG. 3B, and otherwise the process considers optimality constraints provided by the advisory layer and available renewable energy, and the real-time controller chooses the cheapest source for balancing the load in current time (104). Next, the process supplies the load and then determines whether to charge or discharge the battery (104). Time is incremented (106), and then the process jumps to connector 3 (FIG. 3C).

Turning now to FIG. 3B, from connector 1 of FIG. 3A, the process updates profiles for optimization horizon: forecasted renewable generations; forecasted load; and time-of-use grid electricity price, among others (110). Next, the process updates MPC objective function for battery and grid power cost minimization over the optimization horizon, and it also updates MPC equality and inequality constraints (112). The process then selects the charging or discharging level of battery and its power price for the next one hour operation of real-time controller based on comparison of optimal DoD and battery power price with their initial values (114). The process then sends the optimality constraints to real-time controller in the second layer (116) and jumps to connector 2 (FIG. 3C).

FIG. 3C shows exemplary multi-objective management method for energy cost minimization and battery lifetime maximization. The process first updates profiles of forecasted renewable generations, forecasted load, time-of-use grid electricity price for optimization window, and updates the values of battery depth of discharge (DoD) and battery discharge power of previous step (120). The process then updates the MPC objective function for battery and grid power cost minimization over the optimization horizon and also updates equality and inequality constraints of MPC optimization problem for optimization horizon (122). The process then solves the MPC optimization problem which results in the following control sequences for each time instance of optimization horizon: optimized output of each energy source (renewables & grid) and optimized battery charge & discharge pattern (124). The process then implements just the first element of control sequence at current time for balancing the load and charging or discharging the battery and ignores the rest of control actions (126). The optimization horizon recedes one time step (128) before the process jumps to connector 3.

FIG. 3D is a continuation of FIG. 3C. The process estimates the battery life using DoD and battery discharge power of previous step (130). The process then determines the total number of battery replacement using estimated battery life (132). The process determines equivalent uniform annual cost (EUAC) using capital cost of battery replacements (134) and determines the battery power price using EUAC (136) before looping back to connector 2 (FIG. 3C).

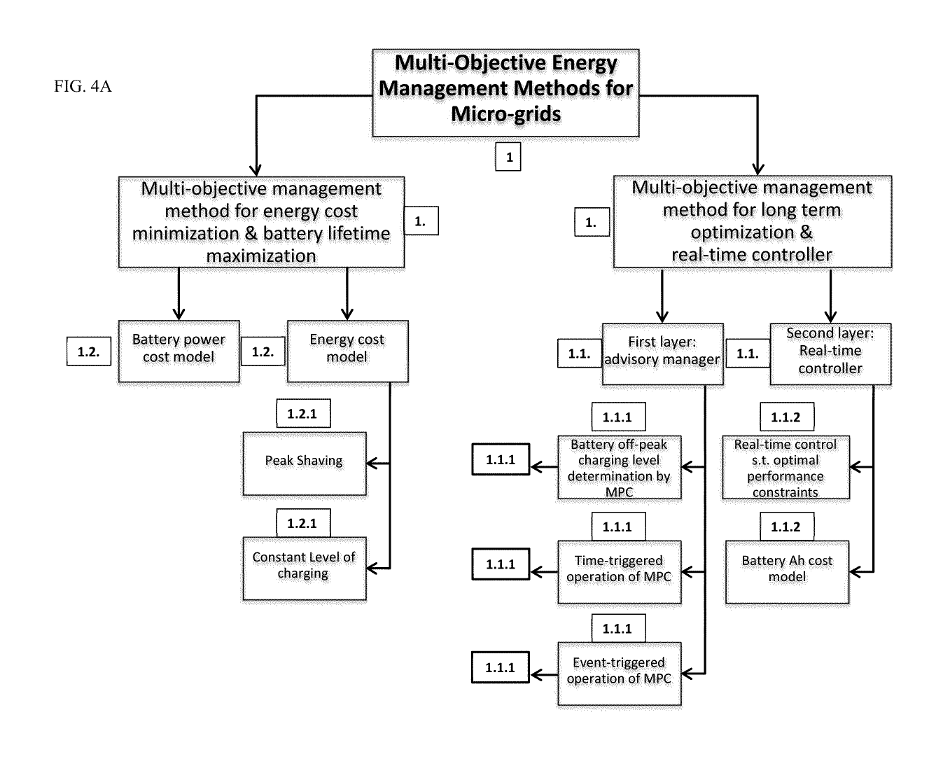

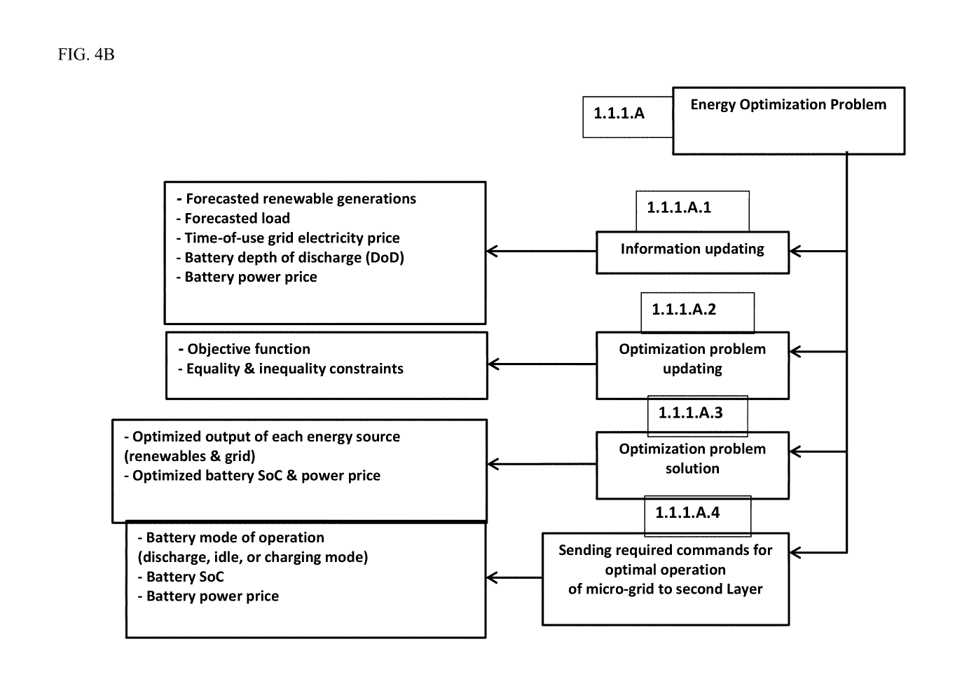

FIGS. 4A-4B shows an exemplary computer for implementing the multi-objective energy management methods for micro-grids 1 including methods for managing the micro-grid operation with different objective functions in order to achieve the most efficient performance 1.

In 1.1, the process includes multi-objective management method for long term optimization and real-time controller: a two-layer management method is used that minimizes the energy cost subject to system constraints such as the equality constraint between supply and demand. It has a long term optimizer in its first layer and a real-time controller in the second layer.

In 1.1.1, the first layer uses the MPC as the advisory manager. The advisory layer employs an MPC to solve a long term optimization problem by utilizing forecasted renewable generation and load profiles. The MPC results will be the optimality conditions which real-time controller uses as optimal performance targets in second layer. The advisory layer can be used in different strategies which will be explained below.
In 1.1.1.1, the battery off-peak charging level is done. A first strategy of using the advisory layer runs the MPC optimization problem once per day at 12:00 am. In this way, considering the forecasted availability of renewable energy for the next 24 hours, the MPC determines the optimal value for off-peak charging of battery by the grid. This optimal value is sent to real-time controller in second layer for implementation.
In 1.1.1.2, the process uses a time-triggered operation of MPC. A second strategy of using the advisory layer runs the MPC regularly for example every one hour. By doing this, MPC results provide hourly constraints for real-time controller which optimize the micro-grid performance.
In 1.1.1.3, the process uses an event-triggered operation of MPC. A third strategy of using the advisory layer is based on event-triggered type of operation. In this way, any time that real-time controller confronts with an unexpected event triggers the MPC in advisory layer to make the optimal decision for dealing with the event.
In 1.1.1.A, the process solves an energy optimization problem. This is the optimization problem which MPC should solve in any type of operation. The following steps are performed to solve the optimization:
   In 1.1.1.A.1, information updating is done. First, required information for forming the optimization problem is updated. This information includes forecasted renewable generations, forecasted load, time-of-use grid electricity price, battery depth of discharge (DoD), and battery power price.
   In 1.1.1.A.2, the optimization problem is updated: With the updated information, the objective function and constraints of optimization problem are updated.
   In 1.1.1.A.3, the process determines an optimization problem solution: Solving the optimization problem, optimal output of each energy source (renewables & grid) and optimal battery SoC and battery power price are obtained.
   In 1.1.1.A.4, the process sends required commands for optimal operation of micro-grid to second Layer. Considering the obtained optimal results, optimal battery mode of operation (discharge, idle, or charging mode), battery SoC, and battery power price are sent to real-time controller in second layer for implementation.

In 1.1.2, the second layer is a real-time controller: In the second layer, the management system controls the micro-grid behavior in a second-by-second basis.

In 1.1.2.1, the real-time control is subject to optimal performance constraints: For performing the second-by-second managing task, the real-time controller solves a one time-step optimization problem subject to advisory layer constraints and available renewable energy at current time. In this way, it guarantees the balance between generation and consumption within the micro-grid at each time step while it satisfies the optimal performance constraints provided by MPC at advisory layer.

In 1.1.2.2, the process determines a battery Amp-hour cost model: For solving the optimization problem in second layer and determining the cheapest source of energy for supply the load, it is needed to model the cost of power extracted from the battery. To this purpose, the Ah cost model has been employed which calculates the price of power stored in the battery.

In 1.2, a multi-objective management method for energy cost minimization & battery lifetime maximization is done. The process determines a dispatching strategy for energy sources within a micro-grid which not only minimizes the marginal cost of operation but also maximizes the storage unit lifetime.

In 1.2.1, an energy cost model is built. In order to minimize the marginal cost of micro-grid operation, one objective function has been dedicated to energy cost models for energy sources. To this end, a linear cost model has been described for each source of energy which is the multiplication of marginal cost of source and its level of generation.

In 1.2.1.1, peak shaving is determined: To perform the peak shaving task, an inequality constraint is added to the problem which restricts the total power extracted from the grid for both load supplying and battery charging at each time instance.

In 1.2.1.2, the process determines a constant level of charging: Due to physical limitations of storage package, battery can be charged just by a constant level of charging. Hence, an equality constraint has been considered in optimization problem which lets the charging power to be either the constant level or zero.

In 1.2.2, the process determines a battery power cost model: To integrate the battery lifetime maximization objective and energy cost minimization objective into one optimization problem, we have utilized a model which translates the battery lifetime maximization objective into a battery power cost minimization one.

As discussed above, the multi-objective management system to control the operation of a micro-grid. Two objectives are focused on to obtain the optimal performance of the micro-grid. The first objective is the minimization of energy operational cost; and the second one is the maximization of battery lifetime. To implement the management process, MPC is used as a powerful solution method to solve the underlying optimization problem.

To investigate the performance of proposed management strategy, a micro-grid including local renewable generations, grid connection, energy storage unit and a load was simulated in MATLAB environment. We compared the performance of MPC algorithm with static methods, and the MPC method obtains 21.6% more saving in energy cost. To demonstrate the effectiveness of considering battery lifetime extension objective, a simulation of one month operation of micro-grid shows that, by considering battery life span maximization objective, the MPC is able to operate the battery for its whole rated life.

The above-described systems and methods can be extended to include real-time information regarding DG power production. The intermittent nature of most DGs, such as wind and photovoltaic (PV) sources introduces a significant uncertainty in the operation of a microgrid. A real-time management system is therefore advantageous, with the objective of the management system being real-time dispatching of energy generations in a way that minimizes the operational cost while it guarantees the balance between supply and demand at the presence of unpredictable variations of DGs and other physical limitations of a real microgrid. The present principles provide a tiered management system including an advisory layer and a real-time layer to address both optimality and feasibility of the solution.

To achieve these aims, the present principles provide an optimization of the microgrid's performance in a first tier by defining long-term (e.g., daily) control strategies, as described in depth above. The second tier provides operation and control of the microgrid in real-time to satisfy operational constraints.

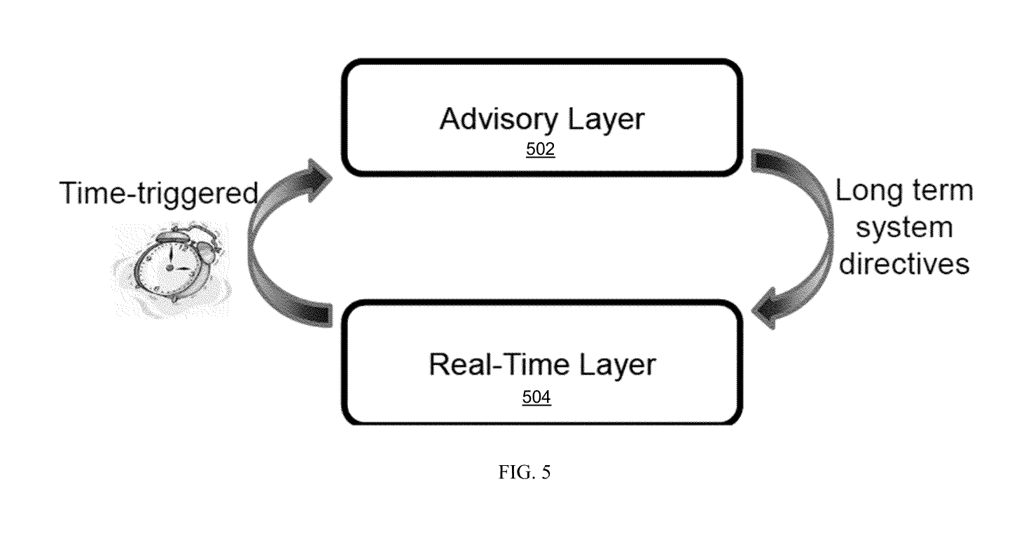

Referring now to FIG. 5, a diagram illustrating the interactions of the first and second tier is shown. The advisory layer 502 is triggered at certain times to gather input data, such as renewable generation and load forecast profiles for the next twenty four hours. The advisory layer 502 then handles the microgrid's efficient operation by formulating the microgrid's model and solving an economic dispatch problem for different sources of energy within the microgrid. The advisory layer 502 also prepares economic long-term directives for the real-time layer 504.

The real-time layer economically operates the microgrid based on long term directives on a minute-by-minute basis and guarantees the reliability of the system by considering all operational constrains. In other words, the real-time layer 504 charges and discharges the storage device (e.g., a battery) and controls the renewable generation and imported power from the grid to supply the load on short timescale (e.g., minute-to-minute).

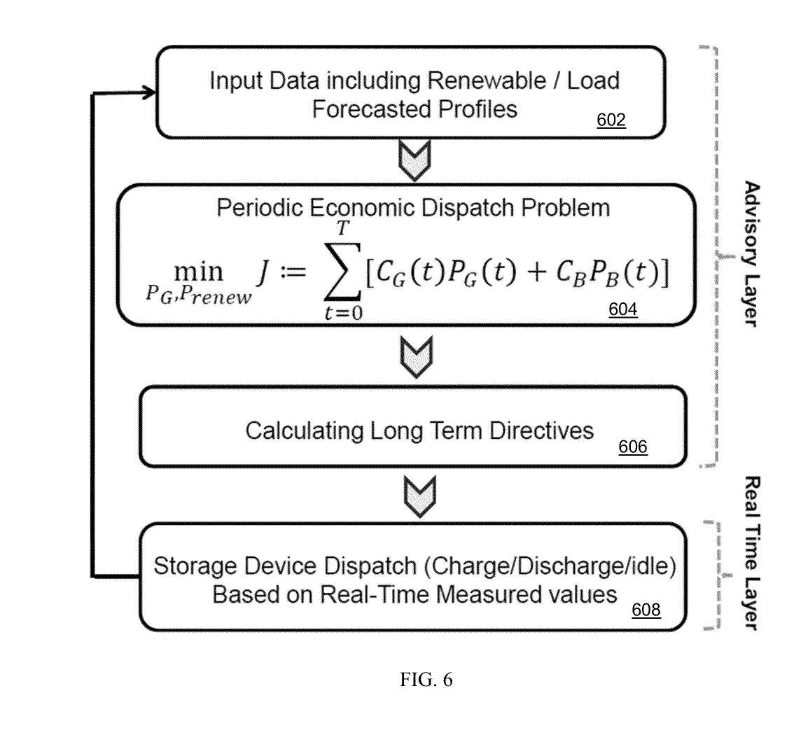

Referring now to FIG. 6, a block/flow diagram of a method for managing a power system using tiered management is shown. Block 602 accepts the inputs to the advisory layer 502, including the forecasted profiles for load over the course of the next 24 hours. Block 604 optimizes a periodic economic dispatch problem to determine the predicted best balance of power use from the grid, batteries, and renewable sources. Block 606 uses these predictions to calculate directives to be used over the course of the day. At the real-time layer 504, block 608 then makes decisions as to how to manage storage devices (e.g., charging, discharging, idle) based on real-time conditions. As it becomes more economical to use battery power, the real-time layer 504 begins to use more power from the batteries, while remaining ready to switch back if circumstances change.

The ED problem for the power system in block 604 can be formulated as follows:

$$min J := {\sum }_{t = 0}^{T} {\sum }_{i = 0}^{N} C ( {P}_{Gen} ( i , t ) )$$

subject to:

$${\sum }_{i = 0}^{N} {P}_{Gen} ( i , t ) = {P}_{load} ( t )$$

$${P}_{Gen} ( i , t ) ∈ ( i )$$

where J is the economic dispatch objective function (total cost of generation), T is the optimization horizon, N is the number of generators in power system, C(PGen(i, t)) is the cost of generating power PGen for generator i at time t, PLoad(t) is the power system load at time t, and C(i) is the set of constraints for generator i. The first equation is the total operational cost for the power system's generators. The second equation describes the balance between supply and demand, which is the primary task for dispatch problem. Finally, the last equation expresses the set of constraints for each generator in a general form.

The output of ED optimization problem for the finite horizon, T, will be the optimal schedule for different generators at different times. This can be summarized in matrix P*_{(N×T)} as follows:

$${P}_{( N \times T )}^{*} = ( \begin{matrix}{P}^{*} ( 1 , 1 ) & {P}^{*} ( 1 , 2 ) & … & {P}^{*} ( 1 , T ) \\ {P}^{*} ( 2 , 1 ) & {P}^{*} ( 2 , 2 ) & … & {P}^{*} ( 2 , T ) \\ ⋮ & ⋮ & ⋱ & ⋮ \\ {P}^{*} ( N , 1 ) & {P}^{*} ( N , 2 ) & …… & {P}^{*} ( N , T )\end{matrix} )$$

in which P*(i,j) is the optimal output power of a generator i at time j. Based on the receding horizon policy, only the optimal elements at the first time step, P*(i, 1), are selected and the rest of the optimal solution will be ignored.

P*_{(N×1)}(i, 1)=(P*(1, 1), P*(2, 1), . . . , P*(N, 1))^{T}

The selected optimal decision, P*(i, 1), is implemented in the system and the system response is measured and saved as the initial condition for the next time step. The ED problem moves forward one step in time and the ED problem is solved for the next horizon, T. The procedure is repeated for all hours of the operation period to complete the ED problem. For power systems that are penetrated by renewable sources, feasibility and optimality of the ED results depend on the accuracy of renewable generation predictions. Utilizing the receding horizon technique allows for the correction and improvement of the forecasting errors at each iteration of the ED problem. In addition, solving a single 24-hour ED optimization problem with minute-based resolution requires significant computational time. The receding horizon strategy shortens the optimization horizon of the ED problem to obtain a reasonable computational time while guaranteeing the optimality of the solution.

As discussed above, the microgrid model can be used to represent a power grid system. Inputs from the microgrid to block 602 may include the predicted load profile, a forecasted renewable generation profile, grid electricity time-of-use profile, and battery characteristics such as an initial state of charge (SoC), SoC upper and lower bounds, and constant charging power.

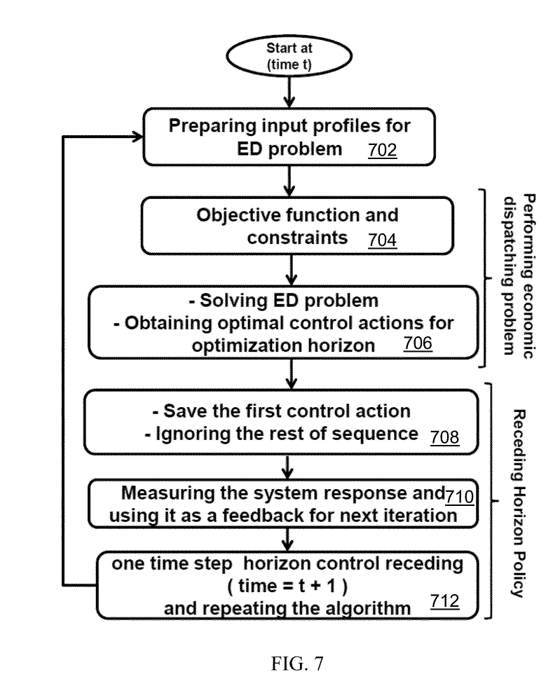

Referring now to FIG. 7, the RHED method is shown for a microgrid. Block 702 accepts the input profiles for the ED problem as discussed above. Block 704 forms the problem as an objective function with constraints. Block 706 solves the ED problem within a given horizon, obtaining a set of optimal control actions for the optimization horizon. Block 708 saves the first control action, ignoring the rest of the sequence, and block 710 measures the system response to that action, saving it for use as feedback. Block 712 advances the horizon by one time step, brining processing back to block 702. This repeats, moving the horizon back by one time step for each iteration, until the full 24 hours have been covered.

The objective function for the microgrid ED problem in block 704 is the total operational cost of energy sources during the optimization horizon, T. The operational cost for the grid power is calculated based on an electricity time-of-use rate profile. The marginal cost of renewable power is assumed to be zero. The battery power cost also equals to zero since the charging cost is already included in the grid power cost. Hence, the ED objective function can be stated as:

$$J := {\sum }_{t = 0}^{T} {C}_{grid} ( t ) {P}_{grid} ( t )$$

where C_{grid}(t) is the grid power cost at time t. The operational constraints for microgrid ED problem include the microgrid model equations set out above. Since all defined parameters are physical variables, another set of constraints is added, which defines them as positive parameters.

P_{grid}^{D}(t)≧0, P_{grid}^{B}(t)≧0, P_{B}(t)≧0,

P_{renew}^{D}(t)≧0, P_{renew}^{D}(t)≧0,

Therefore, the microgrid ED problem for the finite time horizon T can be summarized as:

$${{min}_{{P}_{grid}^{D} , {P}_{renew}^{D} ,}}_{{P}_{grid}^{B} , {P}_{renew}^{B}} J := {\sum }_{t = 0}^{T} {C}_{grid} ( t ) {P}_{grid} ( t )$$

subject to: (4)-(10), (12)

Decision variables for ED problem are P_{G}^{D}, P_{renew}^{D}, P_{G}^{B}, and P_{renew}^{B}. The other variables such as P_{B} and soc are considered as system states and calculated in terms of decision variables.

The ED problem formulated above is a mixed-integer linear optimization problem due to a constant charging power constraint. The solution of the mixed-integer linear ED problem results in a sequence of optimal control actions for grid power and renewable sources to supply the load and/or charge the battery during the optimization horizon, T. The solution for one optimization horizon, P*_{ED}, can be summarized in following matrix:

$${P}_{ED}^{*} = ( \begin{matrix}{P}_{grid}^{D *} ( 1 ) & {P}_{grid}^{D *} ( 2 ) & … & {P}_{grid}^{D *} ( T ) \\ {P}_{grid}^{B *} ( 1 ) & {P}_{grid}^{B *} ( 2 ) & … & {P}_{grid}^{B *} ( T ) \\ {P}_{renew}^{D *} ( 1 ) & {P}_{renew}^{D *} ( 2 ) & … & {P}_{renew}^{D *} ( T ) \\ {P}_{renew}^{B *} ( 1 ) & {P}_{renew}^{B *} ( 2 ) & … & {P}_{renew}^{B *} ( T )\end{matrix} )$$

Based on the receding horizon policy, only the first element of the control sequence, P_{ED}¹*, is saved for the final optimal solution of ED problem.

P_{ED}¹*=(P_{grid}^{D}*(1), P_{grid}^{B}*(1), P_{renew}^{D}*(1), P_{renew}^{D}*(1), P_{renew}^{B}*(1))^{T}

The selected optimal solution, P_{ED}¹*, is implemented on system equations and the system response such as battery SoC and battery charge and discharge power is measured in block 710.

P_{B}*(1)=D_{P}(1)−P_{renew}^{D}*(1)−P_{grid}^{D}*(1)

P_{charge}*(1)=P_{grid}^{B}*(1)+P_{renew}^{B}*(1)

soc*(2)=soc(1)−αP_{B}*(1)+αP_{charge}*(1)

The quantity soc*(2) is also saved for the final optimal solution of the ED problem. It is used as the initial condition for solving the ED problem at the next iteration.

The ED optimization window moves one time step in block 712. The ED problem is solved again and the system response in block 710 is used as the initial condition for this iteration. Considering, for example, n sampling time at each hour, the algorithm is repeated 24×n times for 24 hours of the day. RHED's final optimal solution in the advisory layer is the schedule of the grid power and renewable source for supplying the load and charging the battery. The results can be summarized in matrix P_{RHED}^{opt} as follows:

$${P}_{RHED}^{opt} = ( \begin{matrix}{P}_{grid}^{D opt} ( 1 ) & {P}_{grid}^{D opt} ( 2 ) & … & {P}_{grid}^{D opt} ( n \times 24 ) \\ {P}_{grid}^{B opt} ( 1 ) & {P}_{grid}^{B opt} ( 2 ) & … & {P}_{grid}^{B opt} ( n \times 24 ) \\ {P}_{renew}^{D opt} ( 1 ) & {P}_{renew}^{D opt} ( 2 ) & … & {P}_{renew}^{D opt} ( n \times 24 ) \\ {P}_{renew}^{B opt} ( 1 ) & {P}_{renew}^{B opt} ( 2 ) & … & {P}_{renew}^{B opt} ( n \times 24 )\end{matrix} )$$

The optimal profile for battery SoC based on P_{RHED}^{opt} results is also finalized as follows:

soc_{RHED}^{opt}=(soc_{RHED}^{opt}(1) . . . soc_{RHED}^{opt}(n×24))

Implementing any single point of RHED solution in real time faces difficulty, because the real time renewable generation and demand values would be different from the forecasted profiles. Moreover, the advisory layer schedule is based on RHED which only considers power constraints. In real time, there are other types of constraints such as battery voltage limit, battery full charge conditions, etc., that should be taken into account as well. Therefore, the advisory layer schedule for the energy sources might be infeasible in real time. The critical information from the RHED solution may therefore be extracted and passed to the real-time layer as long-term directives. The long-term directives optimize real time operation of the microgrid and the grid electricity time-of-use rate profile divides the 24 hours of a day into different regions. For example, based on typical tariff rates of a utility company, there are three regions: off-peak time, midpeak (partial-peak) time, and peak time.

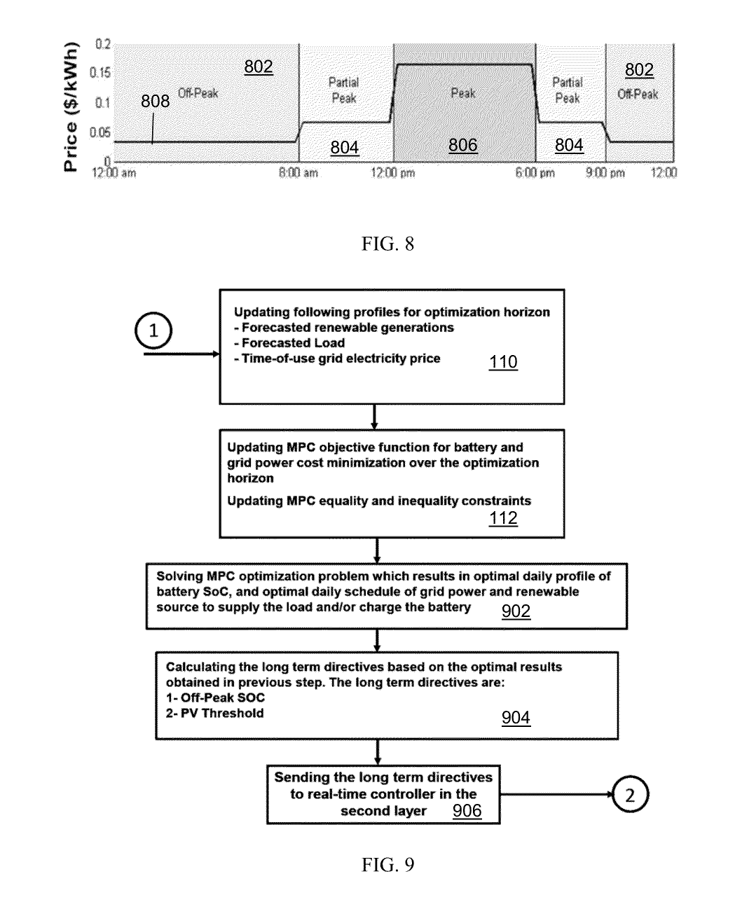

Referring now to FIG. 8, a figure showing exemplary regions of a 24-hour period is shown. The 24-hour period is broken up into off-peak regions 802, partial-peak or midpeak regions 804, and peak region 806. Also shown is a line 808 representing the price charged for electricity from the grid. The price of electricity is quite low during off-peak times 802, rises during midpeak times 804, and is at its highest level during peak times 806.

If there is no renewable generation within the microgrid, and the grid and battery are the only energy providers for the load, the simple strategy to minimize the energy cost is to fully charge the battery in off-peak time 802 and discharge it in peak 806 and mid-peak time 804, depending on the battery capacity. Renewable generation complicates the strategy since its energy cost is free, but is also produced after the off-peak time 802. Without loss of generality, the renewable source may be assumed to be a solar panel for the purposes of the following description—other types of renewable power could also be used instead of, or in addition to, PV power. If the battery gets fully charged in off-peak time, it will not be able to store any excess PV generation that occurs during the day. Therefore, it will be a great advantage to know how much PV charging opportunity will be available during the day. The quantity soc_{RHED}^{opt} provides this information for the real-time layer as follows:
1. The amount of PV charging during midpeak times is measured based on the soc_{RHED}^{opt} profile.
2. The amount of PV charging during the peak time is measured based on the soc_{RHED}^{opt} profile.
3. Based on the midpeak and peak PV charge values, an offpeak SoC is calculated as the first optimal directive for the real-time layer 504, where

Offpeak Soc=100%−Midpeak PV Charge−Peak PV Charge

The Offpeak SoC directive determines how much the battery needs to be charged during off-peak time 802, while maintaining enough extra capacity for PV charging during peak times 806.

As mentioned above, the battery is charged by a constant charging level power. Whenever the excess PV generated is less than the constant charging level, either it should be dumped or some power from the grid should be imported to make the total charging power equal to the constant charging level. For the ED problem in the advisory layer 502, this decision is automatically made by RFIED However, in the real-time layer 504, there is no ED problem and the advisory layer directives, PV Threshold Advices, are used to decide whether to use or dump the excess PV power. Since this decision not only depends on the amount of excess PV, but on the grid tariff rate as well, PV threshold advice for mid-peak time 804, Mid-Peak PV Threshold, is different from advice for peak time 806, Peak PV Threshold. The RHED optimal PV charging profile, P_{renew}^{B opt}, is used to determine PV Threshold Advices as follows:
1. Based on P_{renew}^{B opt}'s charging events in midpeak time 805, a minimum value of charging events is selected as a Midpeak PV Threshold. This guarantees that no economic charging opportunities are missed in midpeak hours calculated by RHED. It should be noted that the battery is assumed herein to be ideal. When considering battery round-trip energy efficiency, it should be expected to have lower values of PV Threshold Advice to compensate for losses resulting from battery energy inefficiency. PV generation during midpeak times that exceeds the Midpeak PV Threshold is used to charge the battery.
2. Based on P_{renew}^{B opt}'s charging events in peak time 806, the minimum value of charging events is selected as Peak PV Threshold. This guarantees that no economic charging opportunities 806 are missed in peak hours calculated by RHED PV generation during peak times 806 that exceeds the Peak PV Threshold is used to charge the battery.

The parameters, offpeak SoC, Midpeak PV Threshold, and Peak PV Threshold are passed to the real-time layer as long term directives to optimize the performance of the management system and microgrid. It should be noted that this method is scalable in terms of different tariff structures. Different regions of any tariff structure are first identified and then the SoC and PV threshold directives are adaptively adjusted based on the identified regions. Even for a flat rate structure, the renewable utilization is maximized by defining a single PV threshold directive.

The real-time layer 504 is the part of control system that connects the management system to the microgrid physical elements and hardware. This layer uses real-time data about the system to satisfy the microgrid's physical limitations and ensure that management system solution is feasible.

Although it is contemplated that the present principles may be applied to any battery technology, the present discussion is set forth with a particular eye toward Lead Acid batteries. Lead Acid batteries should be charged fully after a full discharge cycle to prevent the fast rate collapse of battery voltage during discharge events. Battery voltage collapse prevents the battery from reaching the minimum depth of discharge (DOD) at discharge periods. To perform the full charge cycle, the real-time layer 504 starts to charge the batteries at the beginning of each day, 12:00 AM. To complete the full charge cycle, the battery current in float stage should be less than 3% of the rated current. The battery charging current constraint is checked at each sampling time by the real time layer to complete the full charge cycle. Since no PV generation is available during the off-peak time, the demand is also supplied by the grid power during this period.

After the full charge stage, the batteries should be discharged to create enough capacity for PV charging opportunities during the day hours. The Offpeak SoC directive provided by the advisory layer 502 defines this PV charging capacity limit. Therefore, real-time layer 504 starts to supply the load by discharging the battery up to Offpeak SoC level.

For the rest of the day, the real-time layer 504 manages the microgrid to supply the load and charge/discharge the batteries using a rule-based economic analysis of the availability of energy sources, long term directives of advisory layer, and battery operational and physical constraints. It first measures the PV generated power, P_{PV}(t), and demand, D(t) at time t. Assuming that the priority of PV generation is to supply the load, the real-time controller calculates the mismatch power, P_{mismatch}(t), as follows:

P_{mismatch}(t)=P_{PV}(t)−D(t)

If there is any excess PV generation at time t, P_{mismatch}(t)>0, it might be used to charge the battery based on battery SoC and one of the following situations:
1. If P_{mismatch}(t)≧constant charging level, the battery is charged by excess PV power.
2. In midpeak time (t ∈ midpeaktime), if Midpeak PV Threshold≦P_{mismatch}(t)<constant charging level, the battery is charged in midpeak time by a combination of excess PV power and grid power to reach constant charging level.
3. In peak time (t ∈ peaktime), if Peak PV Threshold≦P_{mismatch}(t)<constant charging level, the battery is charged in peak time by a combination of excess PV power and grid power to reach the constant charging level.
4. Otherwise, when the excess PV power is less than PV Threshold Advice, it will be dumped and the batteries will not be charged.

When the load is more than PV generation (P_{mismatch}(t)<0), the management system needs to either import some power from the grid or discharge the battery to supply the net demand, D(t)−P_{PB}(t). To make the decision, the real-time layer 504 should calculate the cost of power stored in the battery to compare it with grid electricity price. To obtain the battery power cost, it may be assumed that the battery initially has X[kWh] stored energy at time t with the cost of

$${C}_{B} ( t ) [ \frac{\$}{kWh} ] .$$

At any charge event (P_{mismatch}(t)>0) for the time period of Δt, the battery power cost, C_{B}(t+Δt), is updated based on:

$${C}_{B} ( t + Δ t ) = \frac{{C}_{B} ( t ) X + {C}_{grid} ( t ) {P}_{grid}^{Batt} ( t ) Δ t}{X + constant charging level \times Δ t}$$

in which P_{grid}^{Batt}(t) is the imported grid power that adds to excess PV power to reach the constant charging level. Note that the PV power is assumed to be cost free.

To supply the net demand, real-time layer compares the grid electricity rate with the battery power cost, C_{B}(t), and discharges the batteries if the following constraints are satisfied:

1) C_{B}(t)<C_{grid}(t)

2) SoC(t)>soc^{min}

3) V_{battery}(t)>V_{battery}^{min}

The first constraint discharges the battery whenever its cost is cheaper than grid price. Note that in the case of considering battery energy efficiency (η), the battery power cost should be first divided by η, which increases its cost. The second constraint states the battery should not be discharged lower than the minimum allowable SoC. The SoC is calculated based on Ah model (charge and discharge power) stated above. Since this is not an exact method to estimate the battery SoC, the real-time layer also checks the battery terminal voltage to avoid the deep discharge of batteries. V_{battery}^{min} in the third constraint is selected in a way that the battery voltage, V_{battery}, keeps a reasonable margin from the battery cut-off voltage.

In addition to the above-mentioned cost-based discharge rules, real-time layer 504 discharges the batteries whenever the net demand is greater than peak shaving limit, P_{PSH}. In this mode, the battery output power, P_{B} (t), compensates the difference between net demand and peak shaving limit as follows:

P_{B}(t)=(D(t)−P_{PV}(t))−P_{PSH}

This mode guarantees that the imported power from the grid is always less than the peak shaving limit.

Referring now to FIG. 9, an alternative embodiment of the method set forth in FIGS. 3A-3D is shown, with FIG. 9 replacing the steps of FIG. 3C. After the MPC objective function is updated in block 112, block 902 solves the optimization problem to produce an optimal profile of battery SoC and an optimal schedule of grid power for the day. Block 904 calculates long-term directives based on the results of block 904 that include the offpeak SoC and the PV threshold discussed above. Block 906 then sends these long-term directives to the real-time controller 504.

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

By way of example, a block diagram of a computer to support the system is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

Those skilled in the art can now appreciate from the foregoing description that the broad teachings of the present invention can be implemented in a variety of forms. As can be appreciated, steps of methods disclosed and claimed can be performed in an order that is different than that described and claimed herein without departing from the spirit of the present invention. Therefore, while this invention has been described in connection with particular examples thereof, the true scope of the invention should not be so limited since other modifications will become apparent to the skilled practitioner upon a study of the drawings, the specification and the following claims.

What is claimed is:

1. A method to perform multi-objective energy management of micro-grids, comprising:
determining, by an advisory layer with Model Predictive Control (MPC) using a processor, long-term power management directives that include a charging threshold that characterizes one or more power sources, wherein the advisory layer provides optimal set points or reference trajectories to reduce a cost of energy; and
determining real-time actions based on the charging threshold to adaptively charge a battery from the one or more power sources or to discharge the battery.

2. The method of claim 1, wherein the long-term power management directives cover a period over which operation costs are to be minimized.

3. The method of claim 2, wherein the operation period is split into one or more offpeak periods, one or more midpeak periods, and one or more peak periods.

4. The method of claim 3, wherein said long-term power management directives include a midpeak charging/discharging threshold and a peak charging/discharging threshold that govern storage device behavior during the respective midpeak and peak periods.

5. The method of claim 4, wherein determining said real-time actions comprises:
comparing a level of power generation from the one or more power sources to the respective charging threshold for a current time period; and
if the level of power generation exceeds said compared charging threshold, charging a battery with the power generation.

6. The method of claim 5, wherein determining said real-time actions further comprises supplementing the power generation with power from a grid if the power generation is below a constant charging level of the battery and above the charging threshold.

7. The method of claim 4, wherein the long-term directives include an offpeak target state of charge.

8. The method of claim 7, wherein determining said real-time actions comprises charging or discharging the battery to track the offpeak target state of charge.

9. A multi-objective energy management system, comprising:
a processor coupled to a micro-grid;
a long term scheduler in an advisory layer with a Model Predictive Control (MPC) that uses the processor to determine long-term power management directives that include a charging threshold that characterizes one or more power sources; and
a real-time controller that determines real-time actions based on the charging threshold to adaptively charge a battery from one or more power sources or to discharge the battery.

10. The method of claim 9, wherein the long-term power management directives cover a period for which the microgrid operation is to be optimized.

11. The method of claim 10, wherein the operation period is split into one or more offpeak periods, one or more midpeak periods, and one or more peak periods.

12. The method of claim 11, wherein said long-term power management directives include a midpeak charging/discharging threshold and a peak charging/discharging threshold that govern battery behavior during the respective midpeak and peak periods.

13. The method of claim 12, wherein determining said real-time actions comprises:
comparing a level of power generation from the one or more power sources to the respective charging threshold for a current time period; and
if the level of power generation exceeds said compared charging threshold, charging a battery with the power generation.

14. The method of claim 13, wherein determining said real-time actions further comprises supplementing the power generation with power from a grid if the power generation is below a constant charging level of the battery and above the charging threshold.

15. The method of claim 12, wherein the long-term directives include battery state of charge at different moments such as an offpeak target state of charge.

16. The method of claim 15, wherein determining said real-time actions comprises charging or discharging the battery to track the offpeak target state of charge directive assigned by advisory layer.
